(19) United States
(12) Patent Application Publication
(10) Pub. No.: US 2013/0110705 A1
(43) Pub. Date: May 2, 2013

(54) System And Method For Processing Electronic Credit Requests From Potential Borrowers On Behalf Of A Network Of Lenders And Lender Affiliates Communicating Via A Communications Network

(71) Applicant: Thomas Conwell, III, South Lyon, MI (US)

(72) Inventor: Thomas Conwell, III, South Lyon, MI (US)

(21) Appl. No.: 13/666,264

(22) Filed: Nov. 1, 2012

Related U.S. Application Data
(60) Provisional application No. 61/554,489, filed on Nov. 1, 2011.

(51) Int. Cl. G06Q 40/02

(52) U.S. Cl. 705/38

(57) ABSTRACT

A credit request referral service implements a method of processing borrower initiated electronic credit requests from potential borrowers on behalf of a network of lenders and lender affiliates communicating via a communications network. The method includes receiving a borrower initiated credit request, having lender identification data unique to a lender, on a credit referral computing device via a communications network from a borrower using a computing device and retrieving essential lender information for the lender from a database based on the lender identification data. The method further includes generating a borrower data input interface customized with preferences of the lender and displaying the essential lender information, producing a credit analysis report based on borrower data received from the borrower via the borrower data input interface, and providing notification of the borrower initiated credit request to the lender.

### BACKGROUND

The adoption of information technology in the lending industry continues to accelerate. Fueled by competitive pressures, lenders must seek out every available efficiency provided by information technology. In addition to combating competitive pressures with increased information technology, lenders seek to build networks of affiliates for referring potential new lending clients. Given historic breakdowns in the lending industry and the ever increasing focus on consumer protections, lenders also face ever increasing regulatory burdens.

All of these competing priorities of the lending industry need prompt attention. Lenders need to adapt their business practices by simultaneously implementing information technology, building and retaining affiliate networks, and timely adopting new regulatory requirements. Accordingly, there is a need in the lending industry for an information technology system that implements the latest efficiency practices while simultaneously assisting lenders with building affiliate networks and complying with regulatory requirements.

### SUMMARY OF THE INVENTION

A credit request referral service implements a method of processing borrower initiated electronic credit requests from potential borrowers on behalf of a network of lenders and lender affiliates communicating via a communications network. The method includes receiving a borrower initiated credit request, having lender identification data unique to a lender, on a credit referral computing device via a communications network from a borrower using a computing device and retrieving essential lender information for the lender from a database based on the lender identification data. The method further includes generating a borrower data input interface customized with preferences of the lender and displaying the essential lender information, producing a credit analysis report based on borrower data received from the borrower via the borrower data input interface, and providing notification of the borrower initiated credit request to the lender.

In the disclosed credit request referral service, the borrower initiated credit request may include a request for credit data pertaining to the borrower as well as a request for a determination by the lender of the creditworthiness of the borrower. The credit analysis report may include a tri-merge credit report, a lender checklist, and records of ancillary credit services preformed when fulfilling the borrower initiated credit request.

Another aspect of the credit request referral service facilitates a regulatory compliance requirement of the lender resulting from the borrower initiated credit request. For example, the regulatory compliance requirement of the lender includes displaying a regulatory ID number of the lender as part of the essential lender information, validating an identity of the borrower, accepting payment from the borrower for costs associated with producing the credit analysis report, and submitting regulatory data related to the borrower initiated credit request to a regulatory data reporting service. Additionally, the credit request referral service can export the borrower data received from the borrower to a format configured for importation into a credit application system of the lender.

The borrower data entry interface presented to the borrower for entering borrower data can be embedded in a website controlled by the lender or an affiliate thereof. The lender identification data submitted by the borrower when initiating the borrower initiated credit request can indirectly identify the lender by uniquely identifying an affiliate of the lender. Accordingly, the credit request referral service can also provide notification of the borrower initiated credit request to the affiliate. The lender identification data can be encoded in a Uniform Resource Locater (URL). The URL can be encoded as a quick response (QR) code such that the borrower initiated credit request can be initiated by the borrower through imaging the QR code with an imaging device.

### BRIEF DESCRIPTION OF THE DRAWINGS

The features and advantages of the various exemplary approaches of this disclosure, and the manner of attaining them, will become more apparent and better understood by reference to the accompanying drawings, wherein:

FIG. 1 illustrates an exemplary system for a credit request referral service;

FIG. 2 illustrates the interaction of a borrower with the credit request referral service;

FIG. 3 illustrates an exemplary borrower data entry interface;

FIG. 4 illustrates an exemplary lender checklist provided as part of the credit analysis report;

FIG. 5 illustrates an exemplary notification to a lender;

FIG. 6 illustrates an exemplary notification to an affiliate of a lender;

FIG. 7 illustrates a flowchart depicting exemplary steps and decisions relating to the enrollment of a lender to the credit request referral service;

FIG. 8 illustrates a flowchart depicting exemplary steps and decisions relating to the association of an affiliate to a lender;

FIG. 9 illustrates a flowchart depicting exemplary steps and decisions relating to submitting a credit request from the perspective of a borrower; and

FIG. 10 illustrates a flowchart depicting exemplary steps and decisions relating to processing a credit request from the perspective of the credit request referral service.

### DETAILED DESCRIPTION

While information technology is good in its own right for increasing processing speed and reducing the risks of human error during data transcription and exchange, there are other advantages as well. For example, a lender can narrow the scope of expertise needed to operate an effective lending business through IT outsourcing. By spending less time on non-core business issues, such as IT management, a lender can focus on the aspects of the lending business that actually generate profit. Lending professionals can spend their time finding the best possible borrowers. Accordingly, a credit request referral service 100 should not only effectively outsource the IT infrastructure, but should also seek to facilitate turning lender leads into borrowing clients.

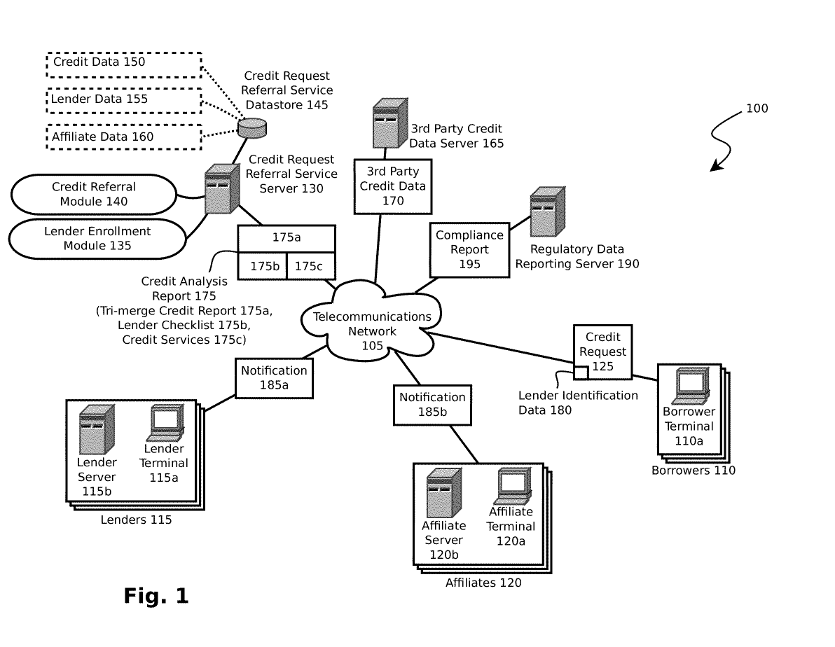

In today's hyper-competitive lending market, lenders must work hard to not only generate leads and referrals, but also quickly transform a referral into a borrowing client. Automating lead and referral generation is a primary goal of the credit request referral service 100 depicted in FIG. 1. While all aspects of the credit request referral service 100 will be discussed in detail below, the following is a brief overview of the interactions of the elements. A telecommunications network 105 connects borrowers 110 with lenders 115 and lender affiliates 120 who are enrolled in the service 100 by passing a borrower initiated credit request 125 to a credit request referral service (CRRS) server 130. The CRRS server 130 includes a lender enrollment module 135 for enrolling lenders and their affiliates into the system 100 and a credit referral module 140 for handling credit requests 125 from borrowers 110.

The borrower initiated credit request 125 broadly includes a borrower's request for credit history data, e.g., a credit report, as well as a request to a lender 115 for the lender's opinion regarding the creditworthiness of the borrower. The borrower 110 might initiate the credit request 125 when applying for a loan or extension of credit from the lender. However, the borrower might also simply be interested in receiving their credit history data and the lender's opinion of their creditworthiness.

The CRRS server 130 is communicatively coupled to a credit request referral service (CRRS) datastore 145, which stores data records such as credit data 150, lender data 155, and affiliate data 160. While processing a borrower initiated credit request 125, the CRRS server 130 may communicate with one or more third party credit data servers 165 to exchange third party credit data 170. The CRRS server 130 generates a credit analysis report 175, including a tri-merge credit report 175a, a lender checklist 175b, and other credit services 175c, which may be provided to the lender 115 and/or the borrower 110. The tri-merge credit report 175a is a standardized report used in the lending industry that combines the borrower's credit report from each of the three national credit reporting bureaus, Experian, TransUnion, and EquiFax. Many lenders require such a tri-merge credit report 175a when processing a loan application from the borrower. Accordingly, by providing the tri-merge credit report 175a as part of the credit analysis report 175, the lender has full knowledge of the borrower's credit history. As will be discussed in more detail below, the lender 115 can selectively require the borrower 110 to cover the costs of third party credit data 170 needed to create the tri-merge credit report 175a, thereby reducing the costs associated with determining the creditworthiness of the borrower.

The lender checklist 175b can summarize some of the more relevant portions a borrower's credit history to assist the lender 115 in determining whether the borrower 110 is credit worthy. Additionally, the lender checklist 175b can provide a set of talking points for discussing with the borrower 110. The talking points can assist the lender 115 with engaging the borrower 110 in a more in depth conversation, rather than simply jumping into a discussion of loan terms and costs. The other credit services 175c provided with the credit analysis report 175 include any credit services that aide the lender with determining the creditworthiness of the borrower and initiating a loan application. For example, the credit services 175c can include authenticating the borrower's identity, obtaining written authorization from the borrower for credit data, complying with fraud detection regulations (automated FCRA/FACTA Red Flag credentialing), providing property/collateral valuations, etc. Data records confirming the completion of these other services 175c may also be provided to the lender 115 as part of the credit analysis report 175.

The CRRS server 130 can provide a notification 185a of a completed borrower initiated credit request 125 to a particular lender 115 based on lender identification data 180 included with the credit request. The lender identification data 180 may identify an affiliate of the lender such that a notification 185b can also be provided to the identified affiliate 120. The CRRS server 130 may also communicate with a regulatory data reporting server 190 in order to submit regulatory data such as a compliance report 195.

The lenders 115 and affiliates may each operate terminals 115a and 120a for enrolling with the service 100 and viewing notifications 185a, 185b. Lender server 115b and affiliate server 120b may provide an initial reception point for a borrower's credit request 125, which is then passed on to the credit request referral service server 130. While the term lender is used herein, it is to be understood throughout this disclosure that the term lender is used in the generic sense to include any lending institution or individual professional thereof, including brokers who may not be directly associated with a specific lending institution.

The telecommunications network 105 is typically provided by one or more a network service providers. The telecommunications network 105 may include both a packet network and a traditional public switch telecommunication network (not shown). Interconnections between packet network, PSTN, and network devices (not shown) may be provided by circuits such as local area networks, digital subscriber lines (DSL), Ti circuits, optical fibers, etc. The telecommunications network 105 may be a local-area network (LAN) or a wide-area network (WAN), and may further be a packet switched communication network such as an Internet Protocol (IP) network. The telecommunications network 105 generally interconnects various computing devices and the like, such as the servers 115a, 120a, 130, 165, 190, and terminals 110a, 115a, 120a. Interconnections to telecommunications network 105 may be made by various media including wires, radio frequency transmissions, optical cables, etc. Other devices connecting to telecommunications network 105, e.g. switches, routers, etc., are omitted for simplicity of illustration in FIG. 1.

Each of the servers 115a, 120a, 130, 165, 190 may be a server based computing device, such as a web server or web application server, configured to facilitate the credit request referral system 100. However, any computing device having a computer readable medium including instructions for communicating with the telecommunications network 105 and other computing devices may act as servers 115a, 120a, 130, 165, 190. Rather than a standalone computer, the servers 115a, 120a, 130, 165, 190 could be mere processing and memory resources commonly referred to as cloud computing data centers. Moreover, servers 115a, 120a, 130, 165, 190 may be a networked computing device configured with server software for accepting connections via telecommunications network 105. Servers 115a, 120a, 130, 165, 190 may provide a graphical user interface, such as a web-based interface, for use by borrowers 110, lenders 115, and affiliates 120. Servers 115a, 120a, 130, 165, 190 may provide a remote interface such that borrowers 110, lenders 115, and affiliates 120 may interact therewith remotely via the telecommunications network 105. Additionally, the graphical user interface and/or remote interface my allow for automated or agent based interactions with servers 115a, 120a, 130, 165, 190.

The CRRS datastore 145 may be a relational database management system (RDBMS). Many such systems, including SQL Server, Oracle, and MySQL, among others, are generally available. CRRS datastore 145 is configured to store data records such as credit data 150 pertaining to borrower credit history and credit requests, lender data 155 including essential lender information needed for handling credit requests, and affiliate data 160 associating affiliates with lenders. CRRS datastore 145 may store data in row and column table format, and may include multiple tables. A row, or record, includes one or more columns, or fields, holding data values for specifically defined fields. Rows may be uniquely identified by the values of one or more columns. Indexes of one or more columns can be included to aide in searching for particular rows of the table. However, other non-table based storage schemes such as XML, object, NOSQL, etc., may be used by the CRRS datastore 145.

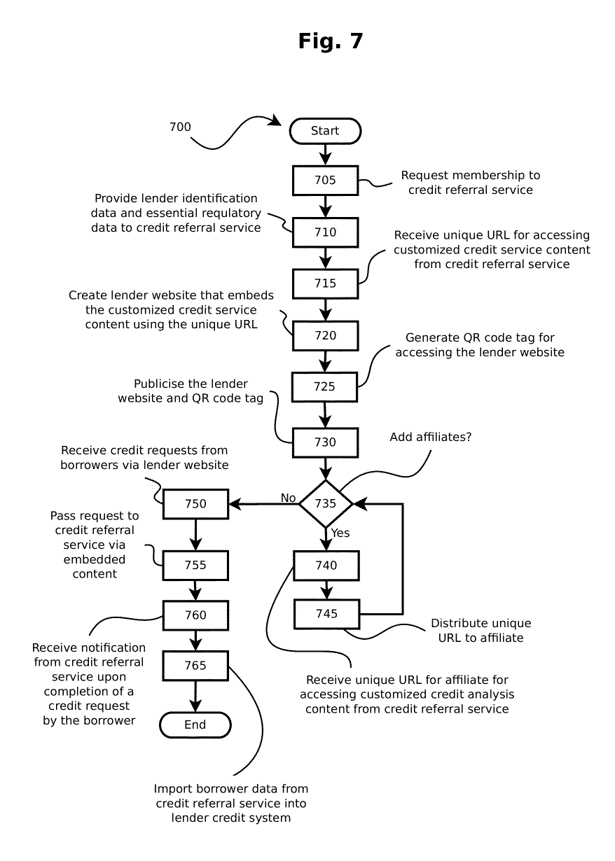

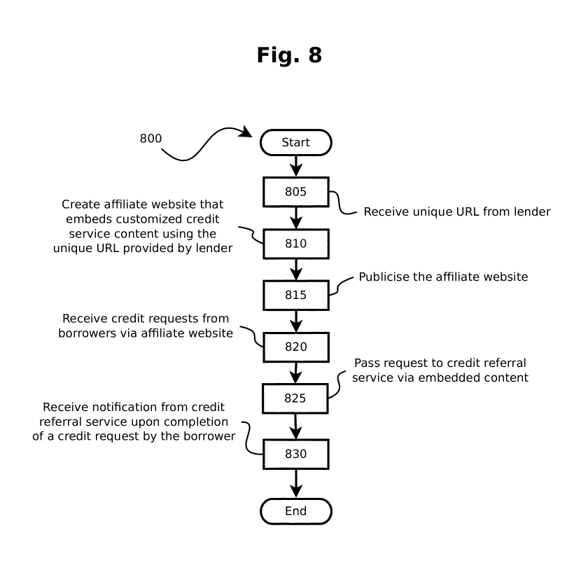

The lender enrollment module 135 may provide computer instructions for enrolling lenders into the credit request referral system 100. Moreover, the instructions may present user interfaces allowing lenders 115 to interact with the CRRS server 130. For example, interfaces may be provided to allow lenders 115 to provide identifying and essential information necessary for handling credit requests 125 on their behalf. Additionally, the instructions and interfaces of the lender enrollment module may allow a lender 115 to specify customized preferences regarding how a credit request should be handled. The lender enrollment module 135 also allow lenders to identify and enroll lender affiliates 120 into the credit request referral system 100. The lender enrollment module 135 further includes instructions for storing lender information and preferences as lender data records 155 and affiliate information as affiliate data records 160 in the CRRS datastore 145. Further details pertaining to the lender enrollment module 135 will be addressed below with respect to FIGS. 7 and 8.

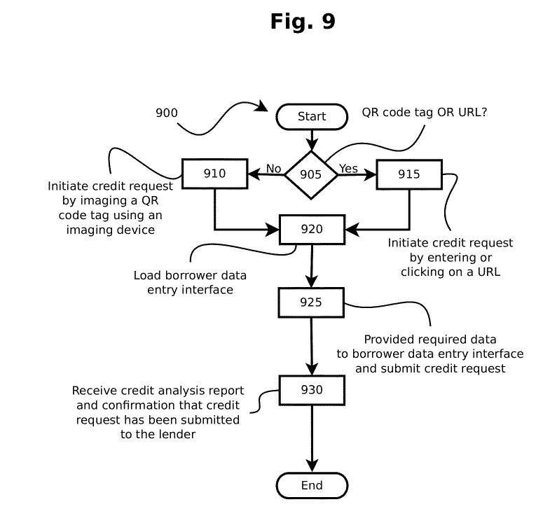

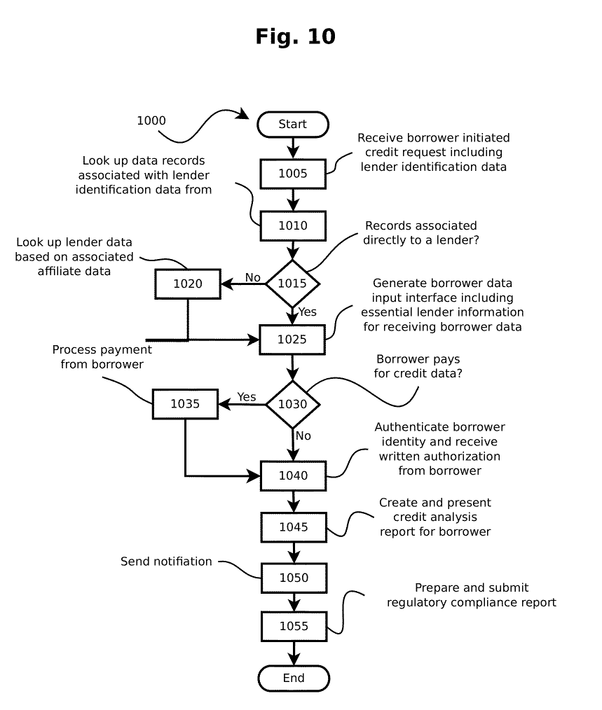

The credit referral module 140 may provide computer instructions for receiving and processing credit requests 125 from borrowers 110. Moreover, the instructions may present user interfaces allowing borrowers 110 to interact with the CRRS server 130. The credit referral module 140 may include instructions for responding to a credit request 125 by: accessing third party data 170 from one or more third party data servers 165; generating and distributing a credit analysis report 175; providing notifications 185a, 185b; and, submitting compliance reports 195 to a regulatory data reporting server 190. While, the instructions of credit referral module 140 may be executed by a user via controls or other interface elements, other instructions may be executed automatically based on a triggering event, or periodically on a set schedule. Further details pertaining to the credit referral module 140 will be addressed below with respect to FIGS. 9 and 10.

Borrower, lender, and affiliate terminals 110a, 115a, and 120a may be any general purpose computing device, such as a PC, smartphone, tablet, or specialized device, connected to the telecommunications network 105. The terminals 110a, 115a, and 120a may have software, such as an operating system with a network protocol stack, for connecting to the CRRS server 130 over the telecommunications network 105. The terminals 110a, 115a, and 120a may have additional software for accessing the user interface provided by the CRRS server 130. For example, the terminals 110a, 115a, and 120a may have web browsing software to access a web based user interface of the CRRS server 130.

Computing devices such as servers 115b, 120b, 130, 165, 195 and terminals 110a, 115a, 120a, etc., may employ any of a number of computer operating systems, including, but by no means limited to, known versions and/or varieties of the Microsoft Windows, the Unix operating system (e.g., the Solaris operating system distributed by Sun Microsystems of Menlo Park, Calif.), the AIX UNIX operating system distributed by International Business Machines of Armonk, N.Y., and the Linux operating system. Computing devices may include any one of a number of computing devices known to those skilled in the art, including, without limitation, a computer workstation, a desktop, a notebook, a laptop, a handheld computer, a tablet computer, a cell phone, a smart phone, or some other computing device capable of communicating and interacting with the CRRS server 130.

Computing devices such as servers 115b, 120b, 130, 165, 190 and terminals 110a, 110b, 115a, 120a, etc., may each include instructions executable by one or more computing devices such as those listed above. Computer-executable instructions may be compiled or interpreted from computer programs created using a variety of programming languages and/or technologies known to those skilled in the art, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored using a variety of known computer-readable media.

A computer-readable medium includes any non-transitory medium that participates in providing data (e.g., instructions), which may be read by a computer. Such a medium may take many forms, including, but not limited to, non-volatile media, and volatile media. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read, but do not include transitory mediums such as signals.

The CRRS datastore 145 may include a query processor that employs Structured Query Language (SQL) in addition to a language for creating, storing, editing, and executing stored procedures, such as the Procedural Language/Structured Query Language (PL/SQL) utilized by Oracle, as mentioned above. Alternatively, the credit request referral service datastore 145 may be a type of database other than an RDBMS such as NOSQL cloud storage system, a hierarchical database, a set of files, an application database in a proprietary format, etc. The CRRS datastore 145 generally includes a computing device employing a computer operating system such as one of those mentioned above, and is accessed via a network in any one or more of a variety of manners, as is well known. Exemplary systems are possible in which at least a portion of the CRRS datastore 145 is provided by a database system used for purposes unrelated to the credit request referral service 100.

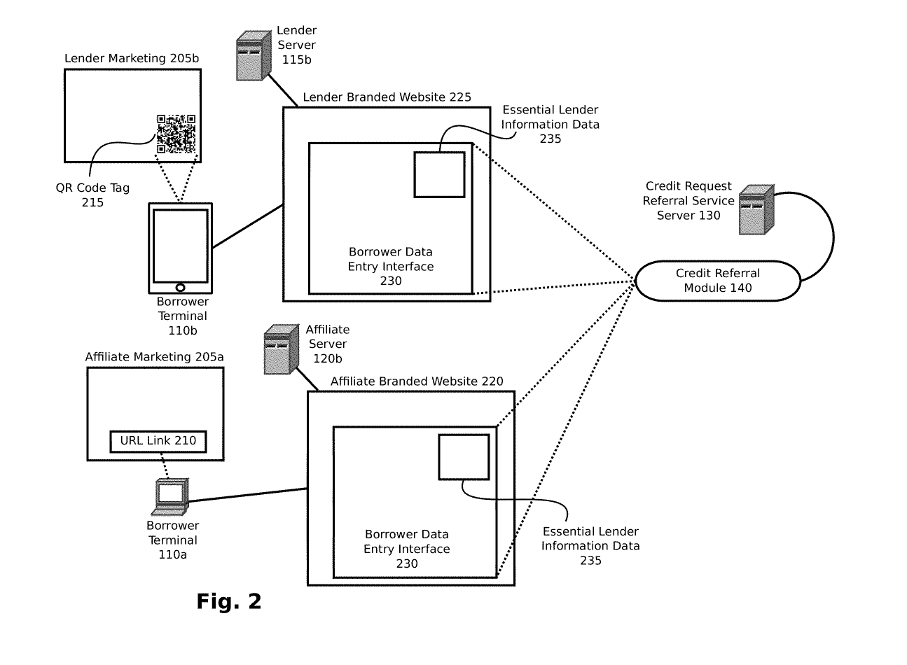

FIG. 2 illustrates the interaction of a borrower 110 with the credit request referral service 100. The credit request referral service 100 enables lenders to transform every marketing publication, email message, blog post, tweet, etc., into a lead generating mechanism. Upon enrollment, a lender 115 receives an embedded content URL 205a for accessing credit request content from the CRRS server 130. This embedded content URL 205a includes lender identification data 180 that uniquely identifies a particular lender among all of the enrolled lenders. Accordingly, when a borrower 110 initiates a credit request 125 that includes a lender's lender identification data 180, the processing of the request can be customized based on the preferences of the lender and the lender can receive a notification 185a upon completion of the credit request by the borrower.

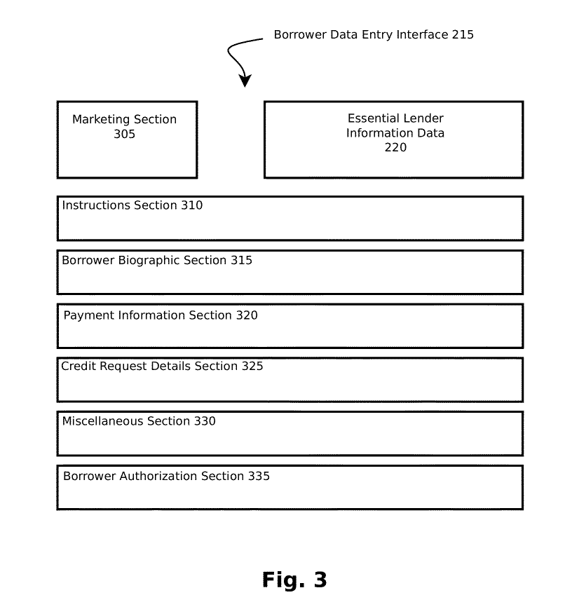

In one exemplary approach, a lender 115, may establish a lender branded website 210 that is branded with the lender's information. The lender branded website 210 can include an area for incorporating embedded content from another server, using standard web design techniques such as frames, iframes, embedded objects, etc. The embedded content is identified and linked using the embedded content URL 205a, which includes the lender identification data 180. For example, the credit request content may include a borrower data entry interface 215 embedded within the lender branded website 210. Additionally, the borrower data entry interface 215 may include an area for displaying essential lender information data 220, such as the identity of the lender as well as a regulatory compliance ID number and information, e.g, a NMLS ID number. The Borrower data entry interface will be discussed in more detail below with respect to FIG. 3.

The lender 115 can publicize the lender branded website 210 by linking thereto in every publication and communication in order to drive new borrower leads. To facilitate access to the lender branded website, the address thereof may be encoded into a so-called Quick Response (QR) code 235. Physical marketing materials 230a may be tagged with the QR code 235. Accordingly, borrower terminals 110b, such as smart phones and tablets, equipped with a camera or other imaging device for imaging the QR code tag 235 can easily access the lender branded website 210.

Similarly, affiliates 120 may establish an affiliate branded website 225. The affiliate branded website 225 would also include an area for incorporating embedded content from another server, using standard web design techniques such as frames, iframes, embedded objects, etc. The embedded content is identified and linked using the embedded content URL 205b, which includes the lender identification data 180. When a lender 115 enrolls an affiliate 120, such as a Realtor, home builder, attorney, etc., the affiliate also receives a unique embedded content URL 205b for accessing credit request content from the CRRS server 130. Accordingly, the lender identification data 180 can uniquely identify both the affiliate 120 and the lender 115. For example, the lender identification data 180 may include two unique identifiers, one identifying the lender and one identifying the affiliate. In another approach, the lender identification data 180 may only include a single unique identifier that must be looked up in the lender and affiliate data records 155, 160 of the CRRS datastore 145 to determine the lender and affiliate to which the credit request was directed.

The affiliate may produce online marketing 230b such as a web page or email message to publicize the affiliate branded website 225. The affiliate marketing 230b may include a URL link 240 for accessing the affiliate branded website 225 and the credit request content from the CRRS server 130 embedded therein. The description provided herein of the lender and affiliate marketing 230a, 230b using a QR code tag 235 and URL link 240 are presented merely as examples of possible marketing techniques. Regardless of the particular marketing technique, lenders 115 and affiliates 120 may market, promote, publicize the lender and affiliates branded websites 210, 225 in order to encourage borrowers to initiate credit requests 125 to the credit request referral service 100.

While the drawing figures depict the lender branded website 210 and affiliate branded website 225 being housed respectively by the lender server 115a and 120a, other arrangements are equally possible. In other exemplary approaches, the CRRS server 130 may host the branded website 210, 225.

FIG. 3 illustrates an exemplary borrower data entry interface 215, which as discussed above, may be embedded within a lender of affiliate branded website 210, 225. The borrower data entry interface 215 not only provides a user interface for accepting borrower data input from the borrower 110, but also provides a space for displaying essential lender information data 220. Consumer credit regulations, which may be imposed by a government, trade group, or other regulatory entity, may require that lenders display certain essential information 220 about the lender 115 to the borrower 110. For example, the essential lender information 220 may include the legal name and address of the business as well as a regulatory ID number assigned by the regulatory entity.

As discussed above, the lender 115 would submit the essential information data 220 to the CRRS server 130 for storage as lender data 155 in the CRRS datastore 145. The borrower data entry interface 215 is generated based on the embedded content URL 205a, 205b used for embedding the credit request content into the lender or affiliate branded website 210, 225. As discussed above, the embedded content URL 205a, 205b includes lender identification data 180 that directly, or indirectly, uniquely identifies a particular lender. Accordingly, when generating the borrower data entry interface 215, the credit referral module 140 can retrieve the lender identification data 180 from the credit request 125 made using the embedded content URL 205a, 205b. For example, the lender identification data 180 may be a unique textual identifier encoded in the embedded content URL 205a, 205b. The credit referral module 140 would use the retrieved lender identification data 180 to look up the applicable essential lender information data from the CRRS datastore 145.

The borrower data entry interface may be customized by preferences set by the lender. Accordingly, the credit referral module may also retrieve customization preferences of the lender from the CRRS datastore based on the lender identification data 180. FIG. 3 broadly depicts various possible sections or areas of the borrower data entry interface 215. However, it should be appreciated that alternative sections and arrangements would also be possible. In one exemplary approach, the borrower data entry interface includes a marketing section 305 for including branding information of the credit request referral service 100 and/or the lender and affiliate. An instructions section 310 may be included for explaining the credit request process to the borrower 115. A borrower biographic section 315 can accept borrower data input such as the borrower's name, address, identification numbers, etc. The provided borrower data may be used for validating the identity of the borrower.

A payment information section 320 can accept payment information, such as credit card information, from the borrower. Based on the preferences of the lender 115, the borrower 110 may be required to pay some or all of the costs involved in completing the credit request. For example, there may be costs involved with accessing third party credit data 170. By allowing lenders to specify that the borrower should pay the costs of completing the credit request, the lender can significantly reduce the costs related to credit requests and loan initiation.

A credit request details section 325 may accept data pertaining to the purpose and amount of credit that is being requested. Additionally, details pertaining to the asset that the borrower intends to purchase may also be accepted in this section 325. For example, if the borrower initiates the credit request in relation to the purchase of a house, the credit request details section 325 could accept data related to the amount of the loan needed by the borrower as well as details of the house. A lender may establish multiple different borrower data entry interfaces 215 with credit request details sections 325 specific to the purpose of the credit request, e.g., purchasing a home, car, etc.

A miscellaneous section 330 may provide the borrower with further details of the credit request, such as legal notices, an expected follow-up procedure, lender contact information, etc. Finally, a borrower authorization section 335 may be provided to ensure that the borrower is making an informed and affirmative decision to submit the credit request. Such an authorization section 335 may fulfill a regulatory compliance duty imposed on the lender 115.

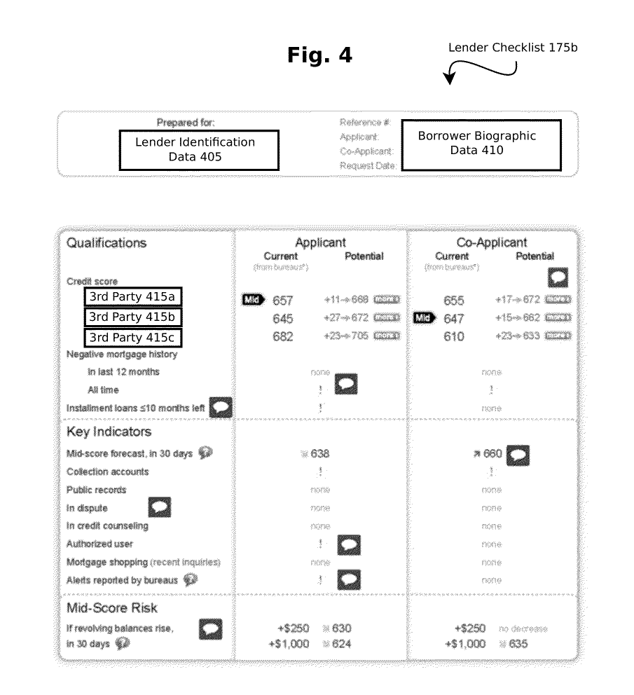

FIG. 4 illustrates an exemplary lender checklist 175a provided as part of the credit analysis report 175 which may be generated at the completion of the credit request 125 by the borrower 110. As discussed above, the credit analysis report 175 includes not only the tri-merge credit report 175a of the borrower's credit history, but also a lender checklist 175b. The lender checklist 175b can summarize some of the more relevant portions a borrower's credit history to assist the lender 115 in determining whether the borrower 110 is credit worthy. Additionally, the lender checklist 175b can provide a set of talking points for discussing with the borrower. While the lender checklist 175b may typically be provided to the lender identified by the lender identification data 180 included in the credit request 125, some or all of the portions of the report 175 may also be provided to the borrower 110. Accordingly, the borrower can learn which, if any, credit issues need to be resolved in order to become credit worthy.

The exemplary lender checklist 175b depicted in FIG. 4 is merely one possible example. Various other possible credit history and analysis may be provided by the lender checklist 175b. In one exemplary approach, the lender checklist 175b includes lender identification data 405, which may be same as the lender essential information 220, or other identifying information of the lender. The borrower biographic data 410 displays some or all of the borrower data submitted in the borrower biographic section 315 of the borrower data entry interface 215. The lender checklist 175b typically summarizes third party credit data 170 provided by third party credit data servers 165. For example, the third party credit data 170 may include credit history or credit reports generated by a national credit reporting bureau, e.g., TransUnion, Experion, Equifax. Additionally, the third party credit data 170 may include a borrower's credit score, e.g., FICO score. While this third party credit data 170 is combined into a tri-merge credit report 175a, some of the more relevant portions may be extracted and used in the lender checklist 175b. The lender checklist 175b may specifically identify the name of the credit bureau that provides the third party data 415a-c. The third party credit data 170 used to generate the tri-merge credit report 175a and lender checklist 175b along with any of the data submitted by the borrower may be stored in the CRRS data store 145 as credit data 150. This credit data 150 may be formatted for direct importation into a computer system of the lender.

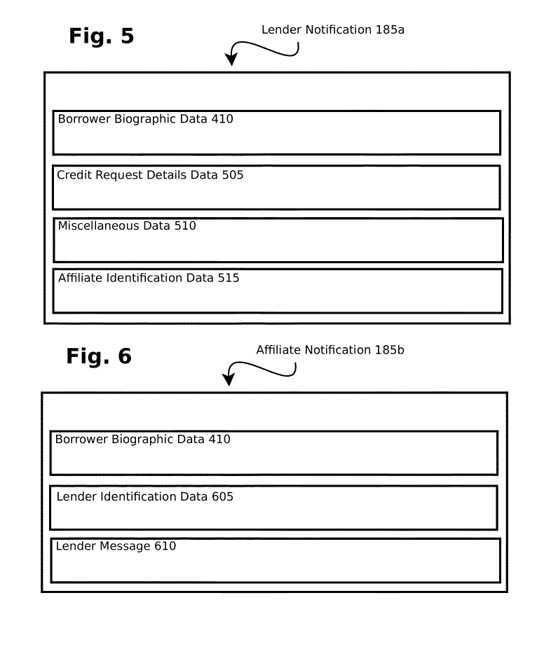

FIGS. 5 and 6 illustrate exemplary lender and affiliate notifications 185a, 185b. In one exemplary approach, the lender notification 185a includes the borrower biographic data 410, credit request details data 505 such as data submitted by the borrower in the credit request details section 325. The lender notification may also include a miscellaneous data section 510, such as instructions to the lender on how to follow-up on the referral notification. If the borrower 110 initiated the credit request 125 by way of an affiliate branded website 225, the lender notification may also include affiliate identification data 515 regarding the particular affiliate that provided the referral. Based on the preferences of the lender, the affiliate notification may include the borrower biographic data 410, lender identification data 605, and a lender message 610, e.g., a thank you message.

FIG. 7 illustrates a flow chart of an exemplary process 700 for enrolling a lender 115 into a credit request referral service 100. The CRRS server 130 and lender server 115b may include a computer-readable medium having stored instructions for carrying out certain operations described herein, including some or all of the operations described with respect to process 700. For example, some or all of such instructions may be included in the lender enrollment module 135. Process 700 is described as an interactive user process. However, it is to be understood that batch, agent, or other types of automated processing techniques may implement the following steps. It should further be understood that despite being presented a sequential process, time delays may occur between steps. For example, steps 750-765 might not occur immediately after preceding steps.

Process 700 begins in step 705 in which the credit request referral service 100 receives an an enrollment request from a lender 115. For example, the CRRS server 130 may provide a user interface, such as a web interface, for receiving an enrollment request from the lender 115. The lender may operate the lender terminal 115a, e.g. through a web browser, to pass the enrollment request over the telecommunications network 105 to the credit request referral service server 130.

Next, in step 710, the lender will provide lender identification data and lender essential data 220 to the credit request referral service 100. For example, the CRRS server 130 may provide a user interface for accepting data input from the lender. A web form, or the like, may include data fields for specifying the information need from the lender, which may be completed by the lender using a web browser or the like on the lender terminal 115a. The CRRS server 130 may also provide an interface for accepting lender preferences pertaining to customizations of the borrower data entry interface 215 and credit request processing. Data provided to the CRRS server 130 by the lender may be stored in the CRRS datastore as lender data 155.

Next, in step 715, the lender will receive an embedded content URL 205a for uniquely identifying embeddable credit request content associated with the lender. For example, the embedded content URL 205a may be presented on a results screen after processing a lender's enrollment request. In another exemplary approach, the embedded content URL 205a may be provided to the lender in an email message, or the like.

Next, in step 720, the lender will establish a lender branded website 210 for embedding the customized credit request content. As explained above, the embedded content URL 205a may be used to link or embed the customized credit request content in a web page using standard techniques such as frames, iframes, embedded objects, etc.

Next, in step 725, the lender may optionally create a QR code 230 encoded with the address of the lender branded website 210.

Next, in step 730, the lender may publicize the lender branded website. For example, the lender may include the link to the website in all electronic communications, web pages, blog posts, electronic forum comments, etc. Additionally, the physical print material an publications 230a, may be tagged with the QR code 235.

Next, in step 735, the lender may determine whether to request additional embedded content URLs 205b for affiliates 120 of the lender 115.

If the lender would like embedded content URLs 205b for affiliates 120, in step 740, the lender may submit a request to the credit request referral service identifying the affiliate. For example, the lender enrollment module may further provide an interface for identifying affiliates of the lender during the enrollment process of the lender. Based on the lender's request, the credit request referral service 100 would provide an embedded content URLs 205b for each of the affiliates.

Next, in step 750, the lender would distribute the embedded content URLs 205b to each of the affiliates, e.g, in an email message or the like.

After completing the affiliate steps 735-745, the process continues to step 750 when a lender receives a borrower initiated request from the borrower 110 through the lender branded website 210. As explained with respect to FIG. 2, the borrower may scan the QR code 235 using a tablet based borrower terminal 110b to arrive at the lender branded website 210.

Next, in step 755, the borrower initiated credit request 125 is passed to the CRRS server 130 via the embedded credit request content. For example, by embedding content using the embedded content URL, the borrower initiated credit request 125 is automatically passed to the CRRS server 130. In effect, the borrower terminal 110a would display content from both the lender branded website 210 and the CRRS server 130.

Next, in step 760, if the borrower completes the credit request using the borrower data entry interface 215, the lender would receive the lender notification 185a from the credit request referral system. For example, the CRRS server 130 may send the notification 185a as an email, text message, XML message, etc. The lender server 115b may be configured to receive the notification 185a for presenting to the lender on the lender terminal 115a.

Next, in step 765, the lender may access the borrower data through the CRRS server for viewing the credit analysis report 175 and third party credit data 170. Additionally, the lender may import the borrower data and third party data 170 into a lender computer system.

After step 765, process 700 ends.

FIG. 8 illustrates a flow chart of an exemplary process 800 for associating an affiliate with a lender. The affiliate server 120b may include a computer-readable medium having stored instructions for carrying out certain operations described herein, including some or all of the operations described with respect to process 800. Process 800 is described as an interactive user process. However, it is to be understood that batch, agent, or other types of automated processing techniques may implement the following steps. It should further be understood that despite being presented a sequential process, time delays may occur between steps. For example, steps 820-830 might not occur immediately after preceding steps.

Process 800 begins in step 805, in which an affiliate receives an embedded content URL 205b that is unique to the affiliate. For example, the affiliate may receive the URL 205b from the lender in an email message or the like.

Next, in step 810, the affiliate will establish an affiliate branded website 225 for embedding the customized credit request content. As explained above, the embedded content URL 205b may be used to link or embed the customized credit request content in a web page using standard techniques such as frames, iframes, embedded objects, etc.

Next, in step 815, the affiliate may publicize the affiliate branded website 225. For example, the affiliate may include the link 240 to the website in all affiliate marketing materials 230b, e.g., electronic communications, web pages, blog posts, electronic forum comments, etc.

Next, in step 820, the affiliate may receive a borrower initiated request from the borrower 110 through the affiliate branded website 225. As explained with respect to FIG. 2, the borrower may use a web browser to follow the link 240 to the lender branded website 224.

Next, in step 825, the borrower initiated credit request 125 is passed to the CRRS server 130 via the embedded credit request content. For example, by embedding content using the embedded content URL 205b, the borrower initiated credit request 125 is automatically passed to the CRRS server 130. In effect, the borrower terminal 110a would display content from both the affiliate branded website 225 and the CRRS server 130.

Next, in step 830, if the borrower completes the credit request using the borrower data entry interface 215, the affiliate would receive an affiliate notification 185b from the credit request referral system 100. For example, the CRRS server 130 may send the notification 185b as an email, text message, XML message, etc. The affiliate server 120b may be configured to receive the notification 185a for presenting to the affiliate on the affiliate terminal 120a.

After step 830, process 800 ends.

FIG. 9 illustrates a flow chart of an exemplary process 900 relating to submitting a credit request from the perspective of a borrower. The borrower terminals 110a, 110b and CRRS server 130 may include a computer-readable mediums having stored instructions for carrying out certain operations described herein, including some or all of the operations described with respect to process 900. While process 900 is described as an interactive user process, it is to be understood that batch, agent, or other types of automated processing techniques may implement the following steps.

Process 900 begins in step 905 when the borrower either initiates a credit request using a QR code 235 or link 240.

In step 910, if the borrower terminal 110b is capable of imaging and processing QR codes, the borrower may initiate the request by scanning the QR code 235 found, for example, on lender marketing material 230a.

In step 915, if the borrower terminal 110a is viewing lender or affiliate marketing material 230b that includes a URL link 240, the borrower may initiate the credit request by following the URL link 240 using a web browser.

Next, in step 920, the borrower data entry interface 215 would be loaded by the borrower terminal 110a, 110b. Due to the embedding of the borrower data entry interface 215 in the lender or affiliate branded websites 210, 225, the interface 215 would be automatically loaded as if it were part of the branded websites 210, 225.

Next, in step 925, the borrower would provide all required data as guided by the borrower data entry interface 215, which was discussed above with respect to FIG. 3.

Next, in step 930 and upon completion of the data entry in step 925, the borrower would receive a credit analysis report 175 and confirmation that the credit request has been provided to the lender. The credit analysis report 175 is discussed above with respect to FIG. 4.

After step 930, process 900 ends.

FIG. 10 illustrates a flow chart of an exemplary process 1000 for processing a credit request from the perspective of the credit request referral service 100. The CRRS server 130 may include a computer-readable medium having stored instructions for carrying out certain operations described herein, including some or all of the operations described with respect to process 1000. For example, some or all of such instructions may be included in the credit referral module 140. While process 1000 is described as an interactive user process, it is to be understood that batch, agent, or other types of automated processing techniques may implement the following steps.

Process 1000 begins in step 1005 in which a borrower initiated credit request 125 including lender identification data 180 is received. For example, the CRRS server 130 may receive a web based request from a borrower via a lender of affiliate branded website 210, 225 that includes an embedded content URL 205a, 205b. As discussed above, while the borrower might direct the request to the branded website 210, 225, due to the embedded content URL 205a, 205b, the request is automatically passed to the CRRS server 130. Also as explained above, the embedded content URL 205a, 205b, may include the lender identification data 180, which can be extracted by the CRRS server 130.

Next, in step 1010, the CRRS server will be queried using the lender identification data 180. For example, the credit referral module 140 may include instructions for formulating a database query to the CRRS server for lender and affiliate data 155, 160 based on the lender identification data 180. In one exemplary approach, the credit referral module 140 may query the CRRS datastore 145 without regard to whether the lender identification data 180 identifies a lender directly or indirectly by identifying an affiliate of the lender.

For example, in step 1015, it may be determined whether the records retrieved from the CRRS datastore pertain to a lender or an affiliate.

In step 1020, if the records retrieved from the CRRS datastore pertain to an affiliate, the CRRS datastore may be further queried to retrieve lender data pertaining to the lender to which the affiliate is associated. For example, the affiliate data may include a reference or identifier of the associated lender that can be used for an additional query of the CRRS datastore 145.

Next, in step 1025, the borrower data input interface may be generated based on the retrieved lender data 155. For example, essential lender information data 220 included in the lender data 155 may be displayed on the borrower data entry interface. As discussed above, the essential lender information data 220 may include such things as the name of the lender, the address of the lender, and a regulatory ID number of the lender, e.g., an NMLS ID number. Additionally, the lender data 155 may include lender preferences pertaining to what data input sections or areas should be included on the borrower data entry input interface 215.

For example, in step 1030, one of the lender preferences may determine whether the borrower is required to submit payment information for the costs associated with handling the credit request.

In step 1035, if, based on the lender preferences, the borrower is required to submit payment information for the costs associated with handling the credit request, the borrower data entry interface may include one or more areas for accepting and processing payment information.

Next, in step 1040, the data entered by the borrower in the borrower data entry interface may be used to authenticate the identity of the borrower. Additionally, authorization from the borrower for accessing third party credit data 170 may be specifically sought. A record of the borrower's authorization may also be stored in the CRRS datastore. Such a record of the borrower's authorization may constitute a borrower's written authorization for accessing third party credit data, which can be valuable to the lender in defending against any claim alleging improper access to credit data. By first authenticating the identity of the borrower, the credibility of the borrower's written authorization can be increased.

Next, in step 1045, the credit analysis report 175 may be created and presented to the borrower. As discussed above, third party data servers 165 may be queried using the borrower data to access third party credit data 170. Upon receipt, the third party credit data 170 may be merged and combined into a tri-merge credit report 175a. Some of the more relevant portions of the tri-merge credit report 175a may be extracted formatted to present a concise lender checklist 175b. In addition to the payment processing, authentication, and authorization credit services 175c discussed above in steps 1035 and 1040, other credit services 175c may also be preformed such as automated Fair Credit Reporting Act (FCRA)/Fair and Accurate Credit Transactions Act (FACTA) Red Flag credentialing and providing property/collateral valuations. Data records confirming the completion of some or all of these other services 175c may also be provided to the lender 115 as part of the credit analysis report 175.

Next, in step 1050, the lender and affiliate may receive notification 185a, 185b of the completed credit request.

Next, in step 1055, a regulatory compliance report 195 pertaining to the credit request may be generated and submitted to a regulator data reporting server 190. In one exemplary approach, a compliance report 195 may be submitted for each credit request. However, in other exemplary approaches, compliance reports 195 may be submitted periodically based on reporting dates, or after a certain number of credit requests.

After step 1055, process 1000 ends.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain systems, and should in no way be construed so as to limit the claimed invention.

Accordingly, it is to be understood that the above description is intended to be illustrative and not restrictive. Many systems and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future systems. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites explicitly to the contrary.

1. A computer implemented method of processing borrower initiated electronic credit requests from potential borrowers on behalf of a network of lenders and lender affiliates communicating via a communications network, the method comprising:
receiving a borrower initiated credit request, including lender identification data unique to a lender, on a credit referral computing device via a communications network from a borrower using a computing device;
retrieving essential lender information for the lender from a database based on the lender identification data;
generating a borrower data input interface customized with preferences of the lender and displaying the essential lender information;
producing a credit analysis report based on borrower data received from the borrower via the borrower data input interface; and
providing notification of the credit request to the lender.

2. The computer implemented method of processing borrower initiated electronic credit requests according to claim 1, wherein the borrower initiated credit request includes a request for credit data pertaining to the borrower as well as a request for a determination by the lender of the creditworthiness of the borrower.

3. The computer implemented method of processing borrower initiated electronic credit requests according to claim 1, wherein the credit analysis report includes a tri-merge credit report, a lender checklist, and records of ancillary credit services preformed when fulfilling the borrower initiated credit request.

4. The computer implemented method of processing borrower initiated electronic credit requests according to claim 1, further comprising facilitating a regulatory compliance requirement of the lender resulting from the borrower initiated credit request.

5. The computer implemented method of processing borrower initiated electronic credit requests according to claim 4, wherein the regulatory compliance requirement of the lender includes at least one of displaying a regulatory ID number of the lender as part of the essential lender information, validating an identity of the borrower, accepting payment from the borrower for costs associated with producing the credit analysis report, and submitting regulatory data related to the borrower initiated credit request to a regulatory data reporting service.

6. The computer implemented method of processing borrower initiated electronic credit requests according to claim 1, wherein the borrower data entry interface is embedded in a website controlled by the lender or an affiliate thereof.

7. The computer implemented method of processing borrower initiated electronic credit requests according to claim 1, wherein the lender identification data indirectly identifies the lender by uniquely identifying an affiliate of the lender.

8. The computer implemented method of processing borrower initiated electronic credit requests according to claim 7, further comprising providing notification of the borrower initiated credit request to the affiliate.

9. The computer implemented method of processing borrower initiated electronic credit requests according to claim 1, further comprising exporting the borrower data received from the borrower and at least a portion of the credit analysis report to a format configured for importation into a credit application system of the lender.

10. The computer implemented method of processing borrower initiated electronic credit requests according to claim 1, wherein the lender identification data is encoded in a Uniform Resource Locater (URL).

11. The computer implemented method of processing borrower initiated electronic credit requests according to claim 10, wherein the URL is encoded as a quick response (QR) code and wherein the borrower initiated credit request is initiated by the borrower through imaging the QR code with an imaging device.

12. A system for processing borrower initiated electronic credit requests, comprising:
a credit request referral server connected to a telecommunications network including a credit referral module and configured to exchange electronic communications over the network with a plurality of borrowers, lenders, and lender affiliates; and
a datastore communicatively coupled to the server and configured to store borrower credit data, lender identification data, essential lender information data, and data pertaining to associations between the lenders and the lender affiliates,
wherein the credit referral module is configured to:
receive a borrower initiated credit request, including lender identification data unique to a lender, on the credit request referral server via a communications network from a borrower using a computing device;
retrieve essential lender information for the lender from the datastore based on the lender identification data;
generate a borrower data input interface customized with preferences of the lender and displaying the essential lender information;
produce a credit analysis report based on borrower data received from the borrower via the borrower data input interface; and
provide notification of the credit request to the lender.

13. The system for processing borrower initiated electronic credit requests according to claim 12, wherein the borrower initiated credit request includes a request for credit data pertaining to the borrower as well as a request for a determination by the lender of the creditworthiness of the borrower.

14. The system for processing borrower initiated electronic credit requests according to claim 12, wherein the credit analysis report includes a tri-merge credit report, a lender checklist, and records of ancillary credit services preformed when fulfilling the borrower initiated credit request.

15. The system for processing borrower initiated electronic credit requests according to claim 12, wherein the credit referral module is further configured to facilitate a regulatory compliance requirement of the lender resulting from the borrower initiated credit request.

16. The system for processing borrower initiated electronic credit requests according to claim 15, wherein the regulatory compliance requirement of the lender includes at least one of displaying a regulatory ID number of the lender as part of the essential lender information, validating an identity of the borrower, accepting payment from the borrower for costs associated with producing the credit analysis report, and submitting regulatory data related to the borrower initiated credit request to a regulatory data reporting service.

17. The system for processing borrower initiated electronic credit requests according to claim 12, wherein the borrower data entry interface is embedded in a website controlled by the lender or an affiliate thereof.

18. The system for processing borrower initiated electronic credit requests according to claim 12, wherein the lender identification data indirectly identifies the lender by uniquely identifying an affiliate of the lender.

19. The system for processing borrower initiated electronic credit requests according to claim 18, wherein the credit referral module is further configured to provide notification of the borrower initiated credit request to the affiliate.

20. The system for processing borrower initiated electronic credit requests according to claim 10, wherein the credit referral module is further configured to export the borrower data received from the borrower and at least a portion of the credit analysis report to a format configured for importation into a credit application system of the lender.
